(19) United States
(12) Patent Application Publication
(10) Pub. No.: US 2026/0035992 A1
(43) Pub. Date: Feb. 5, 2026

(54) SLIDABLY EXTENDABLE BARRIER

(71) Applicant: Shengjun ZHANG, Qinghai Province (CN)

(72) Inventor: Shengjun ZHANG, Qinghai Province (CN)

(21) Appl. No.: 19/353,590

(22) Filed: Oct. 8, 2025

Related U.S. Application Data
(63) Continuation-in-part of application No. 19/248,516, filed on Jun. 25, 2025.

(30) Foreign Application Priority Data
Jun. 12, 2025 (CN) 202521205457.6

(51) Int. Cl. E06B 9/06; E06B 9/00

(52) U.S. Cl. CPC E06B 9/06; E06B 2009/002

(57) ABSTRACT

A slidably extendable barrier for placement between two relative positions is provided, including a first sliding partition plate, a second sliding partition plate, a locking assembly, and an adjusting and pressure-applying assembly. The first sliding partition plate and the second sliding partition plate can slide relative to each other along a length direction; the locking assembly is used for optionally locking the first sliding partition plate and the second sliding partition plate along the length direction. The adjusting and pressure-applying assembly enables the slidably extendable barrier to be fixed between the two relative positions. During use, following the logic of “sliding adjustment locking and positioning-pressure-applying fixation”, the core advantages of “flexible adaptation, rapid installation, stability and reliability” are achieved. It is suitable for application scenarios with high requirements on installation convenience, environmental friendliness, and scenario adaptability, integrating functionality and practicability, and enhancing the user experience.

### CROSS-REFERENCE TO RELATED APPLICATIONS

This application is a divisional of, and claims priority under 35 U.S.C. § 120 to, U.S. non-provisional patent application Ser. No. 19/248,516 (the “parent application”), entitled “SLIDABLY EXTENDABLE BARRIER” filed on Jun. 25, 2025, which claims the benefit, under 35 USC § 119(e), of Chinese Patent Application No. 202521205457.6, filed on Jun. 12, 2025 in the China National Intellectual Property Administration (CNIPA), the entire contents of which are incorporated by reference herein.

### TECHNICAL FIELD

The present application relates to the field of building partition devices, and more particularly to a slidably extendable barrier, which is used for adjustable installation between two relatively fixed positions (such as walls, columns, door frames, etc.) to realize the separation and fixation of spaces.

### BACKGROUND OF THE INVENTION

In the prior art, barrier devices used for separating two relative positions usually have problems such as inconvenient adjustment and insufficient fixing stability. Traditional barrier structures are typically of fixed size or only have a simple sliding function in some cases, making it difficult to flexibly expand and accurately fix according to the spatial size of the actual use scenario. For example, when a barrier needs to be installed in passages or spaces of different widths, traditional devices often require complex installation steps or additional auxiliary components, resulting in low use efficiency. In addition, the locking and pressure-fixing structures of existing barriers are usually relatively simple, and they are prone to loosening during use, which affects the stability and safety of the barriers. Therefore, there is an urgent need for a barrier device that can be flexibly slid and expanded in the length direction and can be stably fixed through reliable locking and pressure-applying components.

In view of this, the present application provides a slidably extendable barrier that can effectively solve the above-mentioned problems.

### SUMMARY OF THE INVENTION

To overcome the shortcomings of existing technology, the present application provides a slidably extendable barrier with a simple structure that can flexibly slide and expand along a length direction, and achieve stable fixation through a reliable locking assembly and a pressure-applying assembly. At the same time, it only requires simple installation steps and does not require additional auxiliary components to be fixed in two relative positions, further improving the user's experience.

The technical solution adopted by the present application to solve its technical problem is:
A slidably extendable barrier for placement between two relative positions, including:
a first sliding partition plate, which includes a first frame and extends along length and height directions;
a second sliding partition plate, which includes a second frame and extends along length and height directions, wherein the first sliding partition plate and the second sliding partition plate being able to slide relative to each other along a length direction;
a locking assembly for optionally locking the first sliding partition plate and the second sliding partition plate along the length direction;
adjusting and pressure-applying assembly, when the locking assembly locks the first sliding partition plate and the second sliding partition plate along the length direction, the adjusting and pressure-applying assembly applies pressure to the first sliding partition plate and the second sliding partition plate, thereby gradually applying pressure to the two relative positions, so that the slidably extendable barrier is fixed between the two relative positions.

The beneficial effect of the present application is that, through the setting of the above structure, core advantages of “flexible adaptation, fast installation, and stable reliability” are achieved through a logic of “sliding adjustment-locking and positioning-pressure fixation” during use, especially suitable for application scenarios with high requirements for installation convenience, environmental friendliness (no damage), and scene adaptability, combining functionality and practicality.

### BRIEF DESCRIPTION OF DRAWINGS

To describe the technical solutions in the embodiments of the present application or in the prior art more clearly, the following briefly introduces the accompanying drawings required for describing the embodiments. Apparently, the accompanying drawings in the following description show merely some embodiments of the present application, and a person of ordinary skill in the art may still derive other drawings from these accompanying drawings without creative efforts. In addition, the accompanying drawings is not drawn to a 1:1 scale, and the relative dimensions of each component are only illustrated in the accompanying drawings as an example, not necessarily drawn to true scale.

The present application will be further described below with reference to the accompanying drawings and embodiments.

FIG. 1 is a schematic diagram of an overall structure of a slidably extendable barrier according to the present application from a first angle;

FIG. 2 is a schematic diagram of an overall structure of a slidably extendable barrier according to the present application from a second angle;

FIG. 3 is a first exploded structural schematic diagram of the slidably extendable barrier according to the present application;

FIG. 4 is a second exploded structural schematic diagram of the slidably extendable barrier according to the present application;

FIG. 5 is a cross-sectional schematic diagram of the slidably extendable barrier according to the present application;

FIG. 6 is a structural schematic diagram of a locking assembly 300 of the slidably extendable barrier according to the present application;

FIG. 7 is a structural schematic diagram of an adjusting and pressure-applying assembly 400 of the slidably extendable barrier according to the present application;

FIG. 8 is an enlarged schematic diagram of a circled part A in FIG. 2;

FIG. 9 is an enlarged schematic diagram of a circled part B in FIG. 5;

FIG. 10 is an enlarged schematic diagram of a circled part C in FIG. 5.

### APPENDED DRAWING REFERENCE SIGNS

100—First Sliding Partition Plate; 200—Second Sliding Partition Plate; 300—Locking Assembly; 400—Adjusting And Pressure-Applying Assembly; 500—Fixed Pressure-Applying End Piece; 110—The First Frame; 111—First Outer End Member; 112—First Inner End Member; 1121—Mounting Through-Hole; 113—First Upper End Member; 1131—Upper Hollow Guide Rail; 114—First Lower End Member; 1141, Lower Hollow Guide Rail; 120—First Elongated Member; 121—Elongated Hollow Guide Rail; 130—First Isolation Assembly; 210—Second Frame; 211—Second Outer End Member; 2111, Grasping Structure; 212—Second Upper End Member; 2121—First Fixed Connection End; 2122—First Sliding Connection End; 213—Second Lower End Member; 2131—Second Fixed Connection End; 2132—Second Sliding Connection End; 220—Second Elongated Member; 221—Third Fixed Connection End; 222—Third Sliding Connection End; 2221—Limiting Mounting Hole; 2222—Limiting Element; 223—Locking Position; 2231—Locking Hole; 230—Second Isolation Assembly; 310—Locking Clamping Member; 311—Locking Pin; 312—Second Sliding Clamping Part; 320—Sliding Abutting Member; 321—Sliding Abutting Part; 322—First Sliding Clamping Part; 410—Mounting Base; 411—Adjusting Screw; 4111—Adjusting External Thread; 4112—Adjusting Through-Hole; 420—Adjusting Handle; 421—Adjusting Internal Thread; 422—Adjusting Abutting Part; 510—Mounting Surface; 520—Abutting Surface.

### DETAILED DESCRIPTION OF THE INVENTION

To make the above-mentioned purposes, features and advantages of the present application more obvious and understandable, the specific implementation modes of the present application will be described in detail below with reference to the accompanying drawings. A lot of specific details are set forth in the following description to facilitate a full understanding of the present application. However, the present application can be implemented in many other ways different from those described here, and those skilled in the art can make similar improvements without violating the connotation of the present application. Therefore, the present application is not limited by the specific embodiments disclosed below.

In the description of the present application, it should be understood that if the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like appear, the orientation or positional relationship indicated by these terms is based on the orientation or positional relationship shown in the drawings, which is only for the convenience of describing the present application and simplifying the description, rather than indicating or implying that the device or element referred to must have a specific orientation, be constructed and operated in a specific orientation, and thus cannot be understood as a limitation on the present application.

In addition, if the terms “first” and “second” appear, these terms are only used for descriptive purposes and cannot be understood as indicating or implying relative importance or implicitly indicating the number of indicated technical features. Therefore, the features defined with “first” and “second” may explicitly or implicitly include at least one of the features. In the description of the present application, if the term “plurality” appears, the meaning of “plurality” is at least two, such as two, three, etc., unless otherwise clearly and specifically defined.

In the present application, unless otherwise clearly specified and limited, if the terms “mounted”, “connected”, “connected” and “fixed” appear, they should be understood in a broad sense. For example, it can be a fixed connection, a detachable connection or an integral connection; it can be a mechanical connection or an electrical connection; it can be a direct connection or an indirect connection through an intermediate medium, and it can be the internal communication of two elements or the interaction relationship between the two elements, unless otherwise clearly defined. For those of ordinary skill in the art, the specific meanings of the above-mentioned terms in the present application can be understood according to specific situations.

In the present application, unless otherwise clearly specified and limited, if there is a description such as “the first feature is on or below the second feature”, its meaning may be that the first feature and the second feature are in direct contact, or the first feature and the second feature are in indirect contact through an intermediate medium. Moreover, the first feature being “above”, “over” and “on” the second feature may mean that the first feature is directly above or obliquely above the second feature, or it only means that the horizontal height of the first feature is higher than that of the second feature. The first feature being “below”, “under” and “beneath” the second feature may mean that the first feature is directly below or obliquely below the second feature, or it only means that the horizontal height of the first feature is lower than that of the second feature.

It should be noted that if an element is referred to as being “fixed to” or “disposed on” another element, it can be directly on the other element or there can also be an intermediate element. If an element is “connected” to another element, it can be directly connected to the other element or there can be an intermediate element at the same time. If present, the terms “vertical”, “horizontal”, “upper”, “lower”, “left”, “right” and similar expressions used in the present application are only for the purpose of illustration and do not represent the only implementation mode.

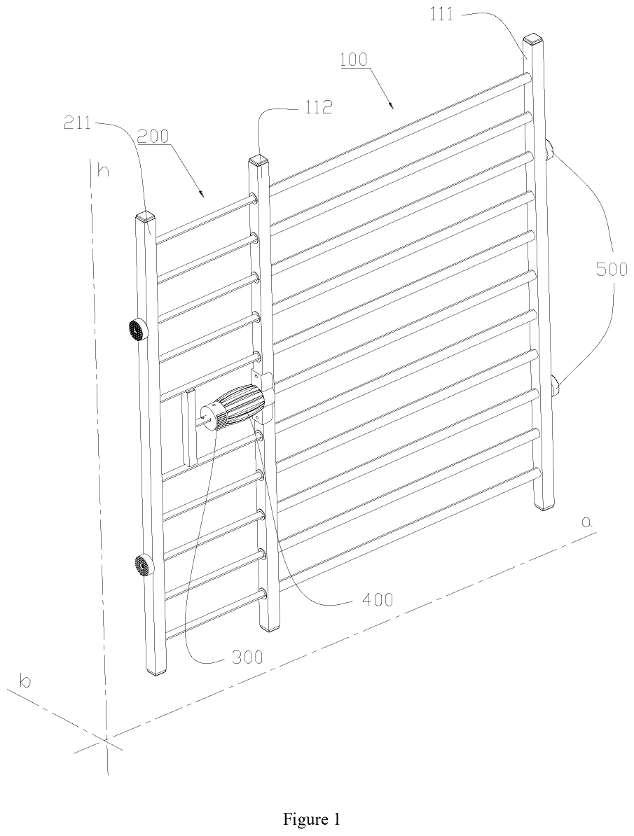

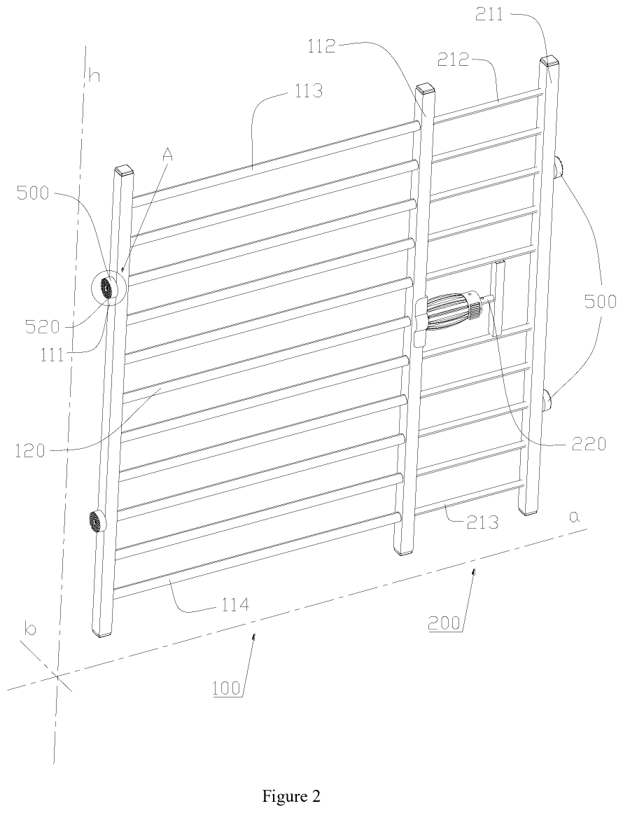

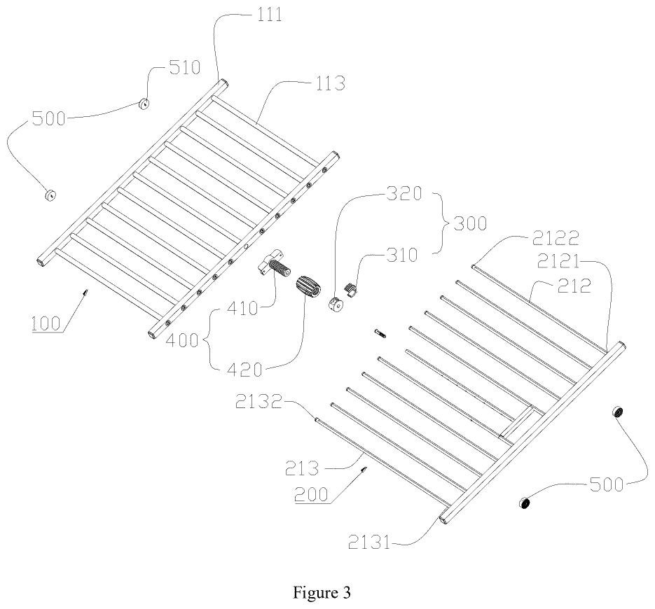

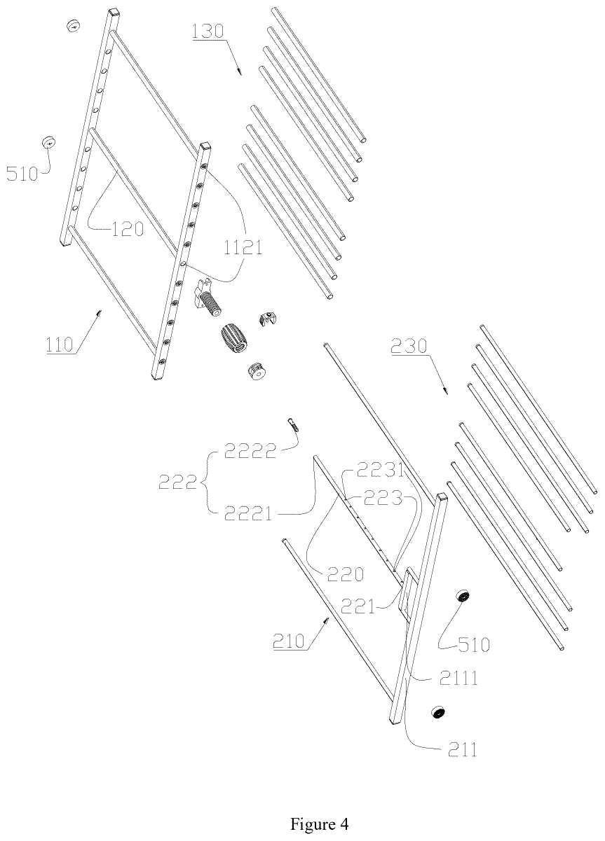

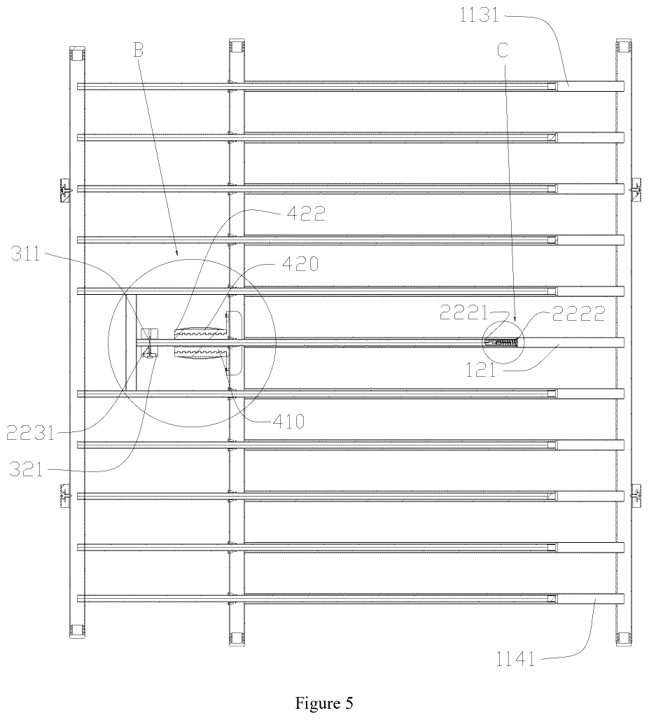

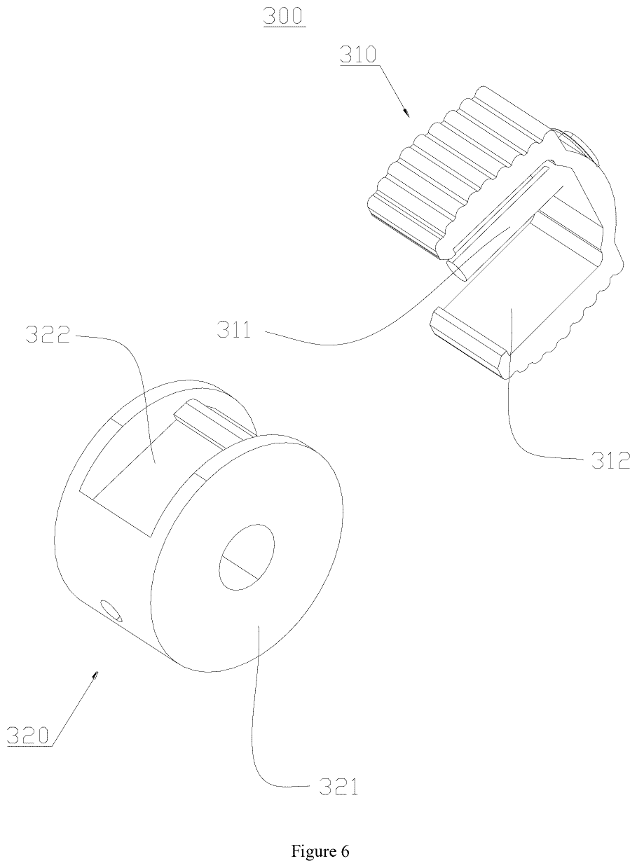

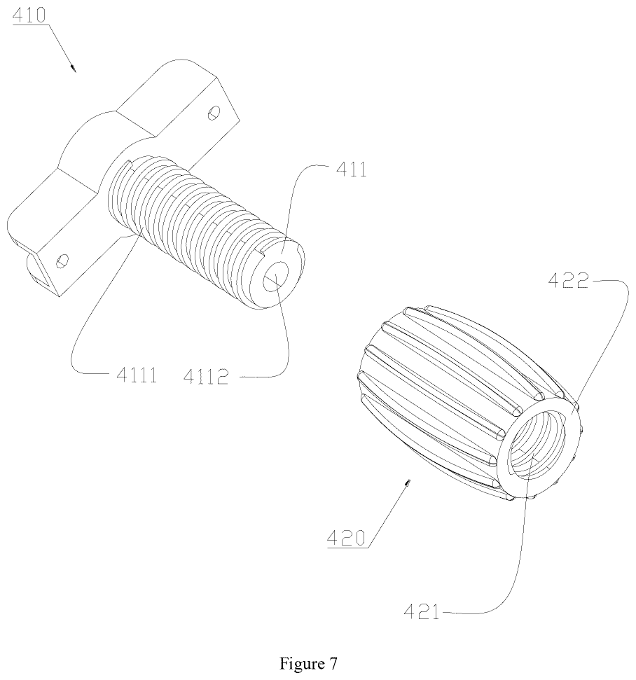

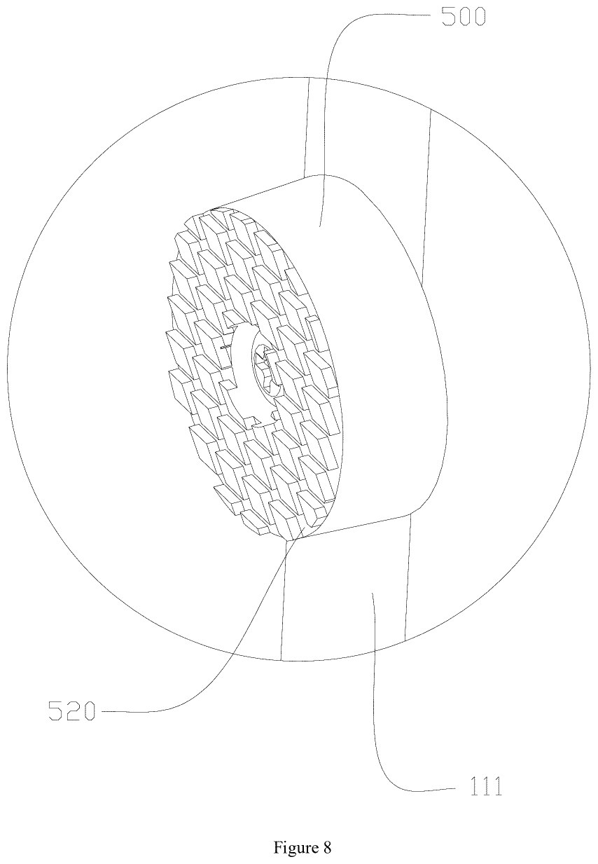

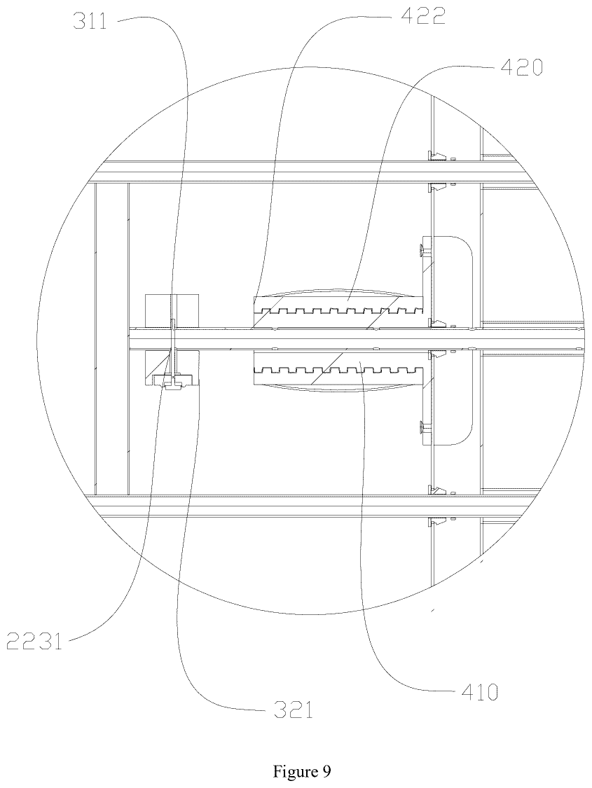

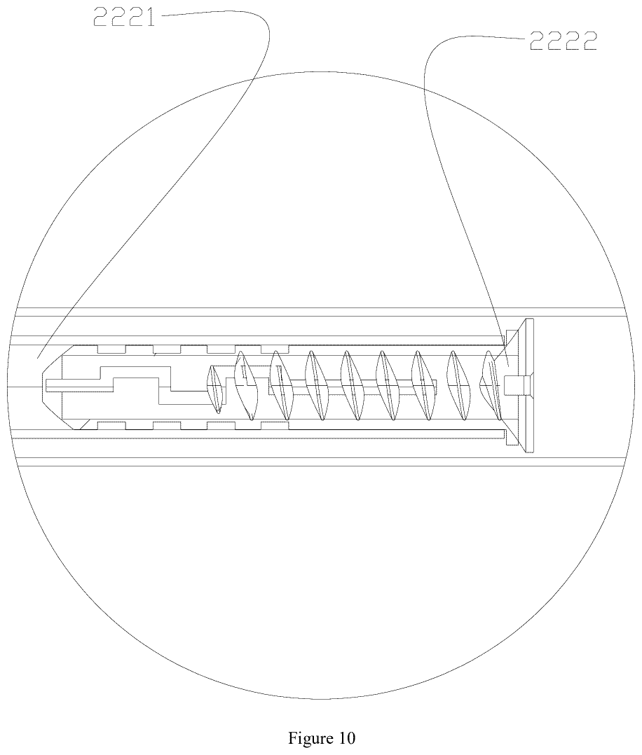

Referring to FIGS. 1 to 10, a slidably extendable barrier for placement between two relative positions, including:
a first sliding partition plate 100, which includes a first frame 110 and extends along length and height directions;
a second sliding partition plate 200, which includes a second frame 210 and extends along length and height directions, and the first sliding partition plate 100 and the second sliding partition plate 200 can slide relative to each other along a length direction;
a locking assembly 300, which is used for optionally locking the first sliding partition plate 100 and the second sliding partition plate 200 along the length direction;
an adjusting and pressure-applying assembly 400, when the locking assembly 300 locks the first sliding partition plate 100 and the second sliding partition plate 200 along the length direction, the adjusting and pressure-applying assembly 400 applies pressure to the first sliding partition plate 100 and the second sliding partition plate 200, thereby gradually applying pressure to the two relative positions, so that the slidably extendable barrier is fixed between the two relative positions.

By setting the above-mentioned structure, the first sliding partition plate 100 serves as a basic structural unit of the barrier during use, extends along the length and height directions, forms a main frame of the barrier, and provides physical support and initial blocking function; the second sliding partition plate 200 cooperates with the first sliding partition plate 100 to change a total length of the barrier through relative sliding, covers spatial gaps of different widths, and improves an application range of the barrier. After the first sliding partition plate 100 and the second sliding partition plate 200 slide to a target length, the locking assembly 300 fixes their relative positions to prevent the partition plates from sliding due to external forces (such as collision, wind pressure, etc.) during use, and ensure a stable position of the barrier. The locking assembly 300 is a key switching component between “sliding adjustment” and “fixed pressure bearing”. Only in a locked state can the adjusting and pressure-applying assembly 400 effectively apply pressure to the barrier to realize the fixation of the barrier between the two relative positions. Through the cooperative action of various structures, the slidably extendable barrier realizes a complete functional chain of “flexible adjustment-reliable locking-stable fixation”, and improves the user's experience. In the present application, the length direction is a direction indicated by an axis a, the width direction is a direction indicated by an axis b, and a height direction is a direction indicated by an axis h.

In the embodiment, the first frame 110 includes a first outer end member 111, a first inner end member 112, a first upper end member 113 and a first lower end member 114, and the second frame 210 includes a second outer end member 211, a second upper end member 212 and a second lower end member 213; the second upper end member 212 includes a first fixed connection end 2121 and a first sliding connection end 2122, and the second lower end member 213 includes a second fixed connection end 2131 and a second sliding connection end 2132. Upper ends of the first outer end member 111 and the first inner end member 112 are fixedly connected through the first upper end member 113, lower ends of the first outer end member 111 and the first inner end member 112 are fixedly connected through the first lower end member 114, an upper end of the second outer end member 211 is fixedly connected to a first fixed connection end 2121 of the second upper end member 212, and a lower end of the second outer end member 211 is fixedly connected to a second fixed connection end 2131 of the second lower end member 213. By setting the above-mentioned structure, during use, the frame structure realizes a stable expansion and sliding function of the barrier device through its specific component design and connection relationship. The first frame 110 adopts a closed rectangular frame composed of the first outer end member 111, the first inner end member 112, the first upper end member 113 and the first lower end member 114, forming a solid main support structure. The second frame 210 includes the second outer end member 211, the second upper end member 212 and the second lower end member 213, and a sliding pair structure with a cantilever sliding end is formed by fixedly connecting the upper and lower ends of the second outer end member 211 to the first fixed connection end 2121 of the second upper end member 212 and the second fixed connection end 2131 of the second lower end member 213 respectively. This design enables the second frame 210 to slide along an inside of the first frame 110 with the first sliding connection end 2122 and the second sliding connection end 2132, to realize the flexible adjustment of the overall length of the barrier. On the one hand, the modular components clarify the functional divisions and enhance the assemblability and reliability of the structure; on the other hand, the distinction between the sliding end and the fixed end not only ensures the smoothness of expansion, but also ensures the overall rigidity and stability of the barrier in the extended state, providing an effective structural foundation for the subsequent locking and pressure-applying functions.

In the embodiment, the first upper end member 113 is hollow to form an upper hollow guide rail 1131, and the first lower end member 114 is hollow to form a lower hollow guide rail 1141. The upper hollow guide rail 1131 matches an outer contour of the second upper end member 212 and forms a sliding fit with the first sliding connection end 2122, and the lower hollow guide rail 1141 matches an outer contour of the second lower end member 213 and forms a sliding fit with the second sliding connection end 2132, so that the first frame 110 is slidably connected to the second frame 210. By accurately matching the upper hollow guide rail 1131 with the outer contour of the second upper end member 212, and forming a sliding fit with the first sliding connection end 2122, and by accurately matching the lower hollow guide rail 1141 with the outer contour of the second lower end member 213 and forming a sliding fit with the second sliding connection end 2132, the sliding connection between the first frame 110 and the second frame 210 is realized. A main function of this design is to provide a stable and smooth relative movement guide, ensure that the barrier does not deviate or get stuck during a expansion and contraction process, and enhance the sliding stability through surface contact guidance, improving the rigidity and movement accuracy of the overall structure; at the same time, the hollow guide rail design realizes a compact spatial layout and provides core movement guarantee for the reliable expansion and contraction of the barrier.

In the embodiment, the first inner end member 112 is provided with a plurality of mounting through-holes 1121, the openings of the upper hollow guide rail 1131 and the lower hollow guide rail 1141 all correspond to one of the plurality of mounting through-holes 1121, the first sliding connection end 2122 passes through the mounting through-hole 1121 and then forms a sliding fit with the upper hollow guide rail 1131, and the second sliding connection end 2132 passes through the mounting through-hole 1121 and then forms a sliding fit with the lower hollow guide rail 1141. By arranging the plurality of mounting through-holes 1121 on the first inner end member 112 and aligning the openings of the upper hollow guide rail 1131 and the lower hollow guide rail 1141 with different mounting through-holes 1121 respectively, a precise assembly path and sliding channel are provided for the first sliding connection end 2122 and the second sliding connection end 2132. A core function of this structure is to realize the smooth connection and reliable guidance between sliding parts of the second frame 210 and internal guide rails of the first frame 110, and ensure the stability and coaxiality of the telescopic movement. The plurality of mounting through-holes 1121 provide assembly tolerance and position adaptability, and improve the universality and adjustability of the parts; the structure in which the sliding connection ends pass through the through-holes and then cooperate with the guide rails not only effectively restricts the degree of freedom of movement and prevents detachment, but also enhances the overall torsional rigidity and movement stability, providing an important structural guarantee for the reliable expansion and contraction of the barrier.

In the embodiment, the first sliding partition plate 100 further includes a first elongated member 120, and the second sliding partition plate 200 further includes a second elongated member 220. One end of the first elongated member 120 is fixedly connected to the first outer end member 111, and the other end is fixedly connected to the first inner end member 112, and the first elongated member 120 is hollow to form an elongated hollow guide rail 121. The elongated hollow guide rail 121 corresponds to one of the plurality of mounting through-holes 1121, the second elongated member 220 includes a third fixed connection end 221 and a third sliding connection end 222, the third fixed connection end 221 is fixedly connected to the second outer end member 211, and the third sliding connection end 222 passes through the mounting through-hole 1121 and then forms a sliding fit with the elongated hollow guide rail 121. By providing the first elongated member 120 fixedly connected at both ends to the first outer end member 111 and the first inner end member 112 in the first sliding partition plate 100, and forming the elongated hollow guide rail 121 inside it, and by providing the second elongated member 220 in the second sliding partition plate 200, fixing the third fixed connection end 221 to the second outer end member 211, the third sliding connection end 222 passes through the mounting through-hole 1121 on the first inner end member 112 and then forms a sliding fit with the elongated hollow guide rail 121. A core function of this structure is to add an important sliding pair located in a middle of the frame between the two sliding partition plates, which together with the upper and lower guide rails forms a multi-point and multi-direction synchronous sliding support system, greatly enhancing the bending and torsional rigidity of the barrier during the expansion and contraction process, and effectively preventing the frame from being deformed or stuck due to single-point force or eccentric load; the middle elongated guide rail cooperates with the upper and lower guide rails to significantly improve the movement stability and overall structural strength, and ensure that the barrier can still run smoothly when expanded in a large span; at the same time, this structure provides a reliable mounting foundation and force transmission path for the subsequent locking and adjusting mechanisms.

In the embodiment, the second elongated member 220 is provided with a plurality of locking positions 223 at intervals, and the locking assembly 300 is slidably mounted on the second elongated member 220 and can lock a sliding stroke range of the second elongated member 220 relative to the first elongated member 120 at any one of the locking positions 223. When the locking assembly 300 is in a locked state at the locking position 223, the adjusting and pressure-applying assembly 400 applies pressure to the first frame 110 and the second frame 210 by abutting against the locking assembly 300, thereby gradually applying pressure to the two relative positions, so that the slidably extendable barrier is fixed between the two relative positions. By setting the plurality of locking positions 223 at intervals on the second elongated member 220, the locking assembly 300 can be slidably mounted on the member and selectively engaged with any one of the locking positions 223, thereby accurately limiting the sliding stroke of the second elongated member 220 relative to the first elongated member 120. This core structure realizes the multi-stage adjustment function of the expansion length of the barrier. The plurality of locking positions 223 provide a wide range of length adaptation and flexible positioning options, greatly enhancing the adaptability of the barrier in different application scenarios. After the locking assembly 300 is locked at the selected position, the adjusting and pressure-applying assembly 400 applies axial pressure to the first frame 110 and the second frame 210 by directly abutting against the locking assembly 300, and finally transmits the acting force to the mounting surfaces of the two relative positions. This design forms an efficient force transmission path, ensuring that the barrier can be firmly fixed at the required position through the friction self-locking method. At the same time, the whole mechanism has the comprehensive advantages of simple operation, reliable locking and high adjustment accuracy.

In the embodiment, the second elongated member 220 is provided with a locking hole 2231 at the locking position 223, the locking assembly 300 includes a locking clamping member 310, the locking clamping member 310 includes a locking pin 311, and the locking pin 311 can be optionally inserted into the locking hole 2231 to lock the locking assembly 300 at the locking position 223. By providing the locking hole 2231 at the locking position 223 of the second elongated member 220, and using the locking clamping member 310 with the locking pin 311, the locking pin 311 can be selectively inserted into the locking hole 2231 to realize mechanical interlocking. A core function of this structure is to provide a simple, reliable and low-cost discrete position locking mechanism for the barrier. The matching mode of the bolt and the locking hole ensures the clarity and high reliability of the locked state, and effectively prevents accidental slipping; the plurality of locking holes 2231 realize the accurate positioning of a plurality of preset lengths, and the user can quickly select and lock the expansion length of the barrier according to needs, with intuitive and simple operation. The whole locking structure is firm and durable, and the force transmission is direct, providing a stable foundation for the subsequent adjusting and pressure-applying operations.

In the embodiment, the locking assembly 300 further includes a sliding abutting member 320, the sliding abutting member 320 includes a sliding abutting part 321 and a first sliding clamping part 322, the locking clamping member 310 further includes a second sliding clamping part 312, and the first sliding clamping part 322 is slidably clamped with the second sliding clamping part 312, so that the locking pin 311 of the locking clamping member 310 can be switched between an inserted position and a pulled out position in the locking hole 2231, thereby switching a locking state and an unlocking state of the locking assembly 300. By arranging the sliding clamping and matching structure between the sliding abutting member 320 and the locking clamping member 310 in the locking assembly 300 during use, stable and rapid switching of the locking function is realized. The sliding abutting part 321 and the first sliding clamping part 322 of the sliding abutting member 320 are clamped with the second sliding clamping part 312 of the locking clamping member 310 and can slide relatively. This design enables the operator to drive the locking pin 311 to accurately enter or exit the locking hole 2231 by pushing or sliding one of the parts, thereby reliably switching between the locking state and the unlocking state. The sliding clamping mechanism provides clear operation feel and state feedback, preventing misoperation; at the same time, the overall structure is compact and the action is reliable, which greatly improves the operation convenience of the barrier length adjustment and the stability of the locking state.

In the embodiment, the slidably extendable barrier further includes a fixed pressure-applying end piece 500, the adjusting and pressure-applying assembly 400 includes a mounting base 410 and an adjusting handle 420, the mounting base 410 is fixedly connected to the first inner end member 112, and the fixed pressure-applying end piece 500 is respectively fixedly connected to the first outer end member 111 and the second outer end member 211. When the locking assembly 300 locks a sliding stroke of the first sliding partition plate 100 and the second sliding partition plate 200 at a proper position in the length direction, the adjusting and pressure-applying assembly 400 applies pressure to the first sliding partition plate 100 and the second sliding partition plate 200, and the fixed pressure-applying end piece 500 applies pressure to the two relative positions, so that the slidably extendable barrier is fixed between the two relative positions. By setting the above-mentioned structure, the final fixing function of the barrier is realized through the cooperative action of the fixed pressure-applying end piece 500 and the adjusting and pressure-applying assembly 400 during use. The fixed pressure-applying end piece 500 is respectively fixedly connected to the first outer end member 111 and the second outer end member 211 to form a direct contact interface with the external mounting surface; the adjusting and pressure-applying assembly 400 is fixed to the first inner end member 112 through the mounting base 410, and its adjusting handle 420 can be operated. After the locking assembly 300 is locked at the predetermined position, operating the adjusting handle 420 will push the entire sliding partition plate system, so that the fixed pressure-applying end piece 500 applies continuously increasing pressure to the external relative positions on both sides. A core function of this structure is to construct a mechanically pressure-applying system that can be accurately controlled. Through a mechanical force-increasing mechanism such as threads, the user can generate a huge axial pressing force with a small operating force, so that the barrier can be firmly pressed between the two relative mounting surfaces to realize reliable self-locking and fixing; the entire pressure-applying process is stable and controllable, and the fixing effect is stable and reliable, which greatly improves the adaptability and practicability of the barrier in various installation environments.

In the embodiment, the fixed pressure-applying end piece 500 includes a mounting surface 510 and an abutting surface 520, the mounting surface 510 is in surface contact with the first outer end member 111 and the second outer end member 211, and the abutting surface 520 abuts against one of the two relative positions. By setting the above-mentioned structure, when in use, the fixed pressure-applying end piece 500 realizes the efficient transmission and reliable fixing of force through its unique mounting surface 510 and abutting surface 520 structures. The mounting surface 510 is in surface contact with the first outer end member 111 and the second outer end member 211, ensuring the uniform distribution of pressure from the frame to the end piece and effectively avoiding stress concentration. The abutting surface 520 directly abuts against the external mounting surface, converting the axial thrust generated by the adjusting and pressure-applying assembly 400 into static friction force. A core function of this design is to construct a stable and efficient force transmission terminal. The surface contact structure greatly improves the stability and bearing capacity of the connection, and effectively prevents local deformation or sliding; at the same time, this structure reliably converts the linear thrust of the internal mechanism into the pressing force on the external mounting surface, and finally enables the barrier to be firmly and stably fixed at the required position, ensuring the reliability and durability of the overall structure.

In the embodiment, the mounting base 410 further includes an adjusting screw 411, the adjusting handle 420 is provided with an adjusting internal thread 421, the adjusting screw 411 is provided with an adjusting external thread 4111 matching the adjusting internal thread 421, and the adjusting handle 420 and the adjusting screw 411 are connected through threads. By adopting the thread matching structure between the adjusting screw 411 and the adjusting handle 420, the precise regulation and mechanical gain of the barrier fixing force are realized. On the one hand, the adjusting external thread 4111 on the outside of the adjusting screw 411 meshes with the adjusting internal thread 421 inside the adjusting handle 420 to form a reliable screw transmission mechanism, which can convert the rotational movement of the adjusting handle 420 into the linear displacement of the adjusting screw 411 along the length direction, and then amplify the operating force through the mechanical characteristics of the thread pair, so that the operator can drive the mechanism with a small acting force. On the other hand, the self-locking characteristic of the thread can effectively prevent the barrier from loosening accidentally after being fixed, which greatly improves the use safety. In this process, only by rotating the adjusting handle 420 can the micro and precise feed adjustment of the adjusting screw 411 be realized, and finally the operator can easily generate sufficient axial pressing force to ensure that the slidably extendable barrier can be firmly and stably fixed between the two relative positions.

In the embodiment, the adjusting screw 411 includes an adjusting through-hole 4112, the adjusting through-hole 4112 corresponds to one of the plurality of mounting through-holes 1121, and the third sliding connection end 222 passes through the adjusting through-hole 4112 and the mounting through-hole 1121 and then forms a sliding fit with the elongated hollow guide rail 121. By accurately aligning the adjusting through-hole 4112 on the adjusting screw 411 with the mounting through-hole 1121 on the first inner end member 112, a through sliding channel is provided for the third sliding connection end 222 of the second elongated member 220. A core function of this structure is to realize the integrated integration of the adjusting mechanism and the sliding guide function. The third sliding connection end 222 passes through the adjusting through-hole 4112 and the mounting through-hole 1121 in sequence and finally cooperates with the elongated hollow guide rail 121, ensuring that the second elongated member 220 can still maintain an accurate linear movement track when bearing the axial pressure generated by the adjusting screw 411, and effectively preventing jamming or eccentric load; at the same time, this integrated design simplifies the structure, saves space, and enables the adjusting and pressure-applying force to be directly and efficiently transmitted to the sliding parts through the adjusting screw 411, finally ensuring the overall rigidity and smooth operation of the barrier expansion and locking.

In the embodiment, an inner diameter of the adjusting through-hole 4112 is smaller than that of the mounting through-hole 1121, an outer diameter of the second elongated member 220 is smaller than that of the adjusting through-hole 4112, the third sliding connection end 222 is provided with a limiting mounting hole 2221 and a limiting element 2222, and a maximum outer diameter of an end of the limiting element 2222 is larger than that of the adjusting through-hole 4112 and smaller than that of the mounting through-hole 1121; after the third sliding connection end 222 passes through the adjusting through-hole 4112, the limiting element 2222 is clamped in the limiting mounting hole 2221, so that the third sliding connection end 222 can pass through the mounting through-hole 1121 and form a sliding fit with the elongated hollow guide rail 121, while not passing out the adjusting through-hole 4112, so as to limit a sliding stroke of the third sliding connection end 222. By designing the matching size relationship among the adjusting through-hole 4112, the mounting through-hole 1121 and the limiting element 2222, a reliable movement stroke limiting mechanism is realized. Its core function is to use the three-stage aperture difference (limiting element>adjusting through-hole>outer diameter of the second elongated member) and the detachable clamping characteristic of the limiting element 2222. It not only ensures that the third sliding connection end 222 can smoothly pass through the mounting through-hole 1121 with a larger aperture and cooperate with the guide rail to complete the sliding function, but also effectively limits the maximum outward sliding stroke of the third sliding connection end 222 through the mechanical interference formed between the limiting element 2222 and the adjusting through-hole 4112 with a smaller aperture. On the premise of not hindering the normal sliding at all, it fundamentally prevents the risk of the second elongated member 220 accidentally falling out of the first elongated member 120, and greatly improves the safety and reliability of the equipment use; at the same time, the limiting structure is compact and efficient, does not occupy additional space, and has a simple assembly process. It is an ingenious and practical solution to realize the terminal protection of the sliding stroke inside the sliding assembly.

In the embodiment, the limiting element 2222 is an expansion screw. In the embodiment, an expansion screw is selected as the limiting element 2222, which provides a simple and reliable implementation scheme for the core movement stroke limiting mechanism. A core function of this design is to use the unique mechanical characteristics of the expansion screw. By installing it in the limiting mounting hole 2221 and expanding it, a firm and non-detachable radial protrusion is formed. Because the diameter of this protrusion is larger than the inner diameter of the adjusting through-hole 4112, it forms an effective mechanical stop. After installation, the expansion screw is integrated with the component, can bear a huge impact load, and effectively prevents the limiting failure caused by vibration and wear during frequent sliding or pressure-bearing processes, which greatly improves the reliability of the stroke protection; at the same time, this scheme has a simple structure and low cost of standard parts, and can realize permanent safety limiting only through one-time simple assembly, which has both high engineering practicability and economy.

In the embodiment, the third sliding connection end 222 is closer to the second outer end member 211 than the first sliding connection end 2122 and the second sliding connection end 2132, so that when the slidably extendable barrier reaches a maximum sliding stroke, the first sliding connection end 2122 and the second sliding connection end 2132 are in the upper hollow guide rail 1131 and the lower hollow guide rail 1141. By arranging the third sliding connection end 222 at a position closer to the second outer end member 211 than the first sliding connection end 2122 and the second sliding connection end 2132, a key safety margin is designed for the core movement mechanism. A core function of this structure is to ensure that when the barrier expands to the maximum designed stroke, the first and second sliding connection ends 2132 can commonly remain in the internal space of the upper hollow guide rail 1131 and the lower hollow guide rail 1141, fundamentally avoiding the risk of the sliding parts completely falling out of the guide rails and ensuring the ultimate safety of the mechanism movement; at the same time, this design ensures that even in the maximum extended state, the upper and lower sliding pairs can still maintain sufficient contact and guidance, thereby maintaining the overall structural rigidity and movement stability, preventing jamming, tilting or deformation problems that may be caused by too long cantilever or loss of guidance, and greatly improving the reliability and service life of the product.

In the embodiment, the adjusting handle 420 includes an adjusting abutting part 422. When the locking assembly 300 locks the sliding stroke of the first sliding partition plate 100 and the second sliding partition plate 200 at a proper position in the length direction, the adjusting handle 420 is rotated to make the adjusting abutting part 422 abut against the sliding abutting part 321, apply pressure to the first sliding partition plate 100 and the second sliding partition plate 200, and the fixed pressure-applying end piece 500 applies pressure to the two relative positions, so that the slidably extendable barrier is fixed between the two relative positions. By setting the above-mentioned structure, during use, a direct and efficient pressure transmission interface is constructed through the adjusting abutting part 422 arranged at the end of the adjusting handle 420. Its core function is that when the locking assembly 300 completes the position locking, the adjusting handle 420 is rotated to push the adjusting abutting part 422 to make mechanical abutment with the sliding abutting part 321 of the locking assembly 300, thereby converting the rotational movement into axial thrust. This design forms a clear force transmission chain-after the torque of the adjusting handle 420 is amplified through the thread pair, it directly acts on the locking assembly 300 through the adjusting abutting part 422, and finally uniformly transmits the pressure to the entire sliding partition plate frame and the fixed pressure-applying end piece 500; this end-abutting mode ensures the directness and controllability of pressure application, and the operator can accurately control the magnitude of the pressing force through the number of rotation turns of the handle. Finally, the barrier can generate huge and stable static friction force, to be firmly fixed between the two relative positions, realizing the high unity of simple operation and reliable connection.

In the embodiment, the second outer end member 211 is provided with a grasping structure 2111, and the third fixed connection end 221 is fixedly connected to the part of the grasping structure 2111 close to the locking assembly 300. By arranging the grasping structure 2111 on the second outer end member 211 and fixing the third fixed connection end 221 of the second elongated member 220 to the part of the grasping structure 2111 close to the locking assembly 300, the functional integration and structural optimization are realized. A core function of this design is to organically combine the force-bearing connection point with the operation function area. The grasping structure 2111 provides a clear, comfortable and ergonomic force-applying point for the user, which greatly facilitates the overall position adjustment of the barrier; at the same time, fixing the third fixed connection end 221 directly to this rigid area shortens the force transmission path, ensures that the adjusting and pressing force borne by the second elongated member 220 can be more directly and efficiently transmitted to the second outer end member 211, thereby improving the response efficiency and connection reliability of the overall structure, avoiding deformation or lag that may be caused by too long force transmission path, and realizing the unity of operation convenience and structural strength.

In the embodiment, the first sliding partition plate 100 further includes a first isolation assembly 130, the second sliding partition plate 200 further includes a second isolation assembly 230, the first isolation assembly 130 is fixedly connected to the first frame 110, the second isolation assembly 230 is fixedly connected to the second frame 210, the first isolation assembly 130 is slidably connected to the second isolation assembly 230, the first isolation assembly 130 is used for reducing the blocking gap in the first sliding partition plate 100, and the second isolation assembly 230 is used for reducing the blocking gap in the second sliding partition plate 200. By arranging the first isolation assembly 130 and the second isolation assembly 230 on the first sliding partition plate 100 and the second sliding partition plate 200 respectively, the gap blocking problem during the expansion and contraction of the barrier is effectively solved. The first isolation assembly 130 and the second isolation assembly 230 are respectively fixedly connected to the first frame 110 and the second frame 210, and at the same time, they form a sliding connection with each other. A core function of this design is to realize the cooperative integration of the isolation function and the movement function.

In the embodiment, the abutting surface 520 is provided with an anti-slip structure. The anti-slip structure may include serrated anti-slip patterns, rubber anti-slip pads, etc. By arranging the anti-slip structure on the abutting surface 520 of the fixed pressure-applying end piece 500, the mechanical connection reliability between the barrier and a mounting surface is significantly improved.

In the embodiment, a direction between the first sliding partition plate 100 and the second sliding partition plate 200 is a width direction, and the first sliding partition plate 100 and the second sliding partition plate 200 are joined and partially overlapped in the width direction. By clearly defining a spatial relationship that the first sliding partition plate 100 and the second sliding partition plate 200 are joined and partially overlapped in the width direction, a core mechanical layout for the barrier to realize the telescopic function is formed. A core function of this structure is to form a continuously controlled sliding surface through the overlapping area. On the one hand, the two parts of the partition plates commonly maintain a certain overlapping area during the expansion and contraction process, which effectively avoids the structural instability or the formation of excessive gaps that may be caused by complete separation, and ensures the integrity and continuity of the barrier at any extended length; on the other hand, this partially overlapped matching mode provides a stable containing and protecting space for the internal sliding guide rails and locking mechanisms, so that the movement is commonly limited within the predetermined track, enhances the torsional rigidity and operation smoothness, and finally ensures that the barrier can work smoothly, reliably and aesthetically during expansion and contraction.

The above are one or more implementation modes provided in combination with specific contents, and it is not considered that the specific implementation of the present application is limited to these descriptions. All technical deductions or replacements made on the premise of the concept of the present application, which are similar or identical to the method and structure of the present application, shall be regarded as the protection scope of the present application.

1. A slidably extendable barrier, for placement between two relative positions, comprising:
a first sliding partition plate, which comprises a first frame and extends along length and height directions;
a second sliding partition plate, which comprises a second frame and extends along length and height directions, wherein the first sliding partition plate and the second sliding partition plate being able to slide relative to each other along a length direction;
a locking assembly for optionally locking the first sliding partition plate and the second sliding partition plate along the length direction;
an adjusting and pressure-applying assembly, when the locking assembly locks the first sliding partition plate and the second sliding partition plate along the length direction, the adjusting and pressure-applying assembly applies pressure to the first sliding partition plate and the second sliding partition plate, thereby gradually applying pressure to the two relative positions, so that the slidably extendable barrier is fixed between the two relative positions.

2. The slidably extendable barrier according to claim 1, wherein the first frame comprises a first outer end member, a first inner end member, a first upper end member, and a first lower end member, and the second frame comprises a second outer end member, a second upper end member, and a second lower end member; the second upper end member comprises a first fixed connection end and a first sliding connection end, the second lower end member comprises a second fixed connection end and a second sliding connection end, upper ends of the first outer end member and the first inner end member are fixedly connected through the first upper end member, lower ends of the first outer end member and the first inner end member are fixedly connected through the first lower end member, and an upper end of the second outer end member is fixedly connected to a first fixed connection end of the second upper end member, and a lower end of the second outer end member is fixedly connected to a second fixed connection end of the second lower end member.

3. The slidably extendable barrier according to claim 1, wherein the first upper end member is hollow to form an upper hollow guide rail, the first lower end member is hollow to form a lower hollow guide rail, the upper hollow guide rail matches an outer contour of the second upper end member and forms a sliding fit with the first sliding connection end, and the lower hollow guide rail matches an outer contour of the second lower end member and forms a sliding fit with the second sliding connection end, so that the first frame is slidably connected to the second frame.

4. The slidably extendable barrier according to claim 1, wherein the first inner end member is provided with a plurality of mounting through-holes, and openings of the upper hollow guide rail and the lower hollow guide rail all correspond to one of the plurality of mounting through-holes, the first sliding connection end passes through the mounting through-hole and then forms a sliding fit with the upper hollow guide rail, and the second sliding connection end passes through the mounting through-hole and then forms a sliding fit with the lower hollow guide rail.

5. The slidably extendable barrier according to claim 1, wherein the first sliding partition plate further comprises a first elongated member, the second sliding partition plate further comprises a second elongated member, one end of the first elongated member is fixedly connected to the first outer end member, the other end of the first elongated member is fixedly connected to the first inner end member, and the first elongated member is hollow to form an elongated hollow guide rail, the elongated hollow guide rail corresponds to one of the plurality of mounting through-holes, the second elongated member comprises a third fixed connection end and a third sliding connection end, the third fixed connection end is fixedly connected to the second outer end member, and the third sliding connection end passes through the mounting through-hole and then forms a sliding fit with the elongated hollow guide rail.

6. The slidably extendable barrier according to claim 1, wherein the second elongated member is provided with a plurality of locking positions at intervals, the locking assembly is slidably mounted on the second elongated member and can lock a sliding stroke range of the second elongated member relative to the first elongated member at any one of the locking positions; when the locking assembly is in a locked state at the locking position, the adjusting and pressure-applying assembly applies pressure to the first frame and the second frame by abutting against the locking assembly, thereby gradually applying pressure to the two relative positions, so that the slidably extendable barrier is fixed between the two relative positions.

7. The slidably extendable barrier according to claim 6, wherein the second elongated member is provided with a locking hole at the locking position, the locking assembly comprises a locking clamping member, the locking clamping member comprises a locking pin, and the locking pin is optionally inserted into the locking hole to lock the locking assembly at the locking position.

8. The slidably extendable barrier according to claim 7, wherein the locking assembly further comprises a sliding abutting member, the sliding abutting member comprises a sliding abutting part and a first sliding clamping part, the locking clamping member further comprises a second sliding clamping part, and the first sliding clamping part is slidably clamped with the second sliding clamping part, so that the locking pin of the locking clamping member can be switched between an inserted position and a pulled out position in the locking hole, thereby switching a locking state and an unlocking state of the locking assembly.

9. The slidably extendable barrier according to claim 8, further comprising a fixed pressure-applying end piece, the adjusting and pressure-applying assembly comprises a mounting base and an adjusting handle, the mounting base is fixedly connected to the first inner end member, the fixed pressure-applying end piece is respectively fixedly connected to the first outer end member and the second outer end member, when the locking assembly locks a sliding stroke of the first sliding partition plate and the second sliding partition plate at a proper position in the length direction, the adjusting and pressure-applying assembly applies pressure to the first sliding partition plate and the second sliding partition plate, and the fixed pressure-applying end piece applies pressure to the two relative positions, so that the slidably extendable barrier is fixed between the two relative positions.

10. The slidably extendable barrier according to claim 9, wherein the fixed pressure-applying end piece comprises a mounting surface and an abutting surface, the mounting surface is in surface contact with the first outer end member and the second outer end member, and the abutting surface abuts against one of the two relative positions.

11. The slidably extendable barrier according to claim 9, wherein the mounting base further comprises an adjusting screw, the adjusting handle is provided with an adjusting internal thread, the adjusting screw is provided with an adjusting external thread matching the adjusting internal thread, and the adjusting handle and the adjusting screw are connected through threads.

12. The slidably extendable barrier according to claim 11, wherein the adjusting screw comprises an adjusting through-hole, the adjusting through-hole corresponds to one of the plurality of mounting through-holes, and the third sliding connection end passes through the adjusting through-hole and the mounting through-hole and then forms a sliding fit with the elongated hollow guide rail.

13. The slidably extendable barrier according to claim 12, wherein an inner diameter of the adjusting through-hole is smaller than that of the mounting through-hole, an outer diameter of the second elongated member is smaller than that of the adjusting through-hole, the third sliding connection end is provided with a limiting mounting hole and a limiting element, and a maximum outer diameter of an end of the limiting element is larger than that of the adjusting through-hole and smaller than that of the mounting through-hole; after the third sliding connection end passes through the adjusting through-hole, the limiting element is clamped in the limiting mounting hole, so that the third sliding connection end can pass through the mounting through-hole and form a sliding fit with the elongated hollow guide rail, while not passing out the adjusting through-hole, so as to limit a sliding stroke of the third sliding connection end.

14. The slidably extendable barrier according to claim 13, wherein the limiting element is an expansion screw.

15. The slidably extendable barrier according to claim 13, wherein the third sliding connection end is closer to the second outer end member than the first sliding connection end and the second sliding connection end, so that when the slidably extendable barrier reaches a maximum sliding stroke, the first sliding connection end and the second sliding connection end are in the upper hollow guide rail and the lower hollow guide rail.

16. The slidably extendable barrier according to claim 9, wherein the adjusting handle comprises an adjusting abutting part, when the locking assembly locks a sliding stroke of the first sliding partition plate and the second sliding partition plate at a proper position in the length direction, the adjusting handle is rotated to make the adjusting abutting part abut against the sliding abutting part, to apply pressure to the first sliding partition plate and the second sliding partition plate, and the fixed pressure-applying end piece applies pressure to the two relative positions, so that the slidably extendable barrier is fixed between the two relative positions.

17. The slidably extendable barrier according to claim 5, wherein the second outer end member is provided with a grasping structure, and the third fixed connection end is fixedly connected to a part of the grasping structure close to the locking assembly.

18. The slidably extendable barrier according to claim 1, wherein the first sliding partition plate further comprises a first isolation assembly, the second sliding partition plate further comprises a second isolation assembly, the first isolation assembly is fixedly connected to the first frame, the second isolation assembly is fixedly connected to the second frame, the first isolation assembly is slidably connected to the second isolation assembly, the first isolation assembly is used for reducing a blocking gap in the first sliding partition plate, and the second isolation assembly is used for reducing a blocking gap in the second sliding partition plate.

19. The slidably extendable barrier according to claim 10, wherein the abutting surface is provided with an anti-slip structure.

20. The slidably extendable barrier according to claim 1, wherein a direction between the first sliding partition plate and the second sliding partition plate is a width direction, and the first sliding partition plate and the second sliding partition plate are joined and partially overlapped in the width direction.
